(19) United States
(12) Patent Application Publication
(10) Pub. No.: US 2017/0110826 A1
(43) Pub. Date: Apr. 20, 2017

(54) SEALING MEMBER AND CONNECTOR

(71) Applicant: YAZAKI CORPORATION, Tokyo (JP)

(72) Inventor: Ryo FUJIKAWA, Shizuoka (JP)

(73) Assignee: YAZAKI CORPORATION, Tokyo (JP)

(21) Appl. No.: 15/292,193

(22) Filed: Oct. 13, 2016

(30) Foreign Application Priority Data
Oct. 16, 2015 (JP) 2015-204692

(51) Int. Cl. H01R 13/52; H01R 13/10

(52) U.S. Cl. CPC H01R 13/5221; H01R 13/10

(57) ABSTRACT

A sealing member includes a wire insertion hole in which an electric wire is to be arranged, and a plurality of lip parts having. a protruding shape provided at intervals in an axial direction on an inner circumferential surface of the wire insertion hole. Each of the lip parts has the protruding shape along an inclined direction with respect to an orthogonal direction to the axial direction of the wire insertion hole, and adjacent ones of the lip parts are arranged in regions that do not overlap in the axial direction of the wire insertion hole.

### CROSS REFERENCE TO RELATED APPLICATION

The present application is based on, and claims priority from Japanese Patent Application No. 2015-204692, filed Oct. 16, 2015, the disclosure of which is hereby incorporated by reference herein in its entirety

### BACKGROUND

Technical Field

The present application relates to a sealing member that prevents intrusion of water or the like into a connector housing, and a connector in which such a sealing member is utilized.

Related Art

A connector that utilizes a sealing member of a conventional example is illustrated in FIG. 7 (see JP 2011-018551 A). In FIG. 7, a terminal housing 52 and a sealing member housing 53 continuous from the terminal housing 52 are formed in a connector housing 51 of a connector 50. The sealing member housing 53 opens at a rear face of the connector housing 51. A sealing member 60 is arranged in the sealing member housing 53.

The sealing member 60 is formed for example of a rubber material having high elastic deformation properties. As illustrated in FIG. 8, the sealing member 60 has a wire insertion hole 61. A first lip part 62 and a second lip part 63 both of which have a protruding shape are formed on the inner circumferential surface of the wire insertion hole 61. The first lip part 62 and the second lip part 63 are respectively arranged to be inclined in the same direction relative to an orthogonal direction S of the axial direction P of the wire insertion hole 61.

In the above structure, a terminal 70 to which an electric wire W is connected is inserted from the sealing member housing 53 that opens at the rear face of the connector housing 51. Then, the insertion tip of the terminal 70 is gradually inserted while stretching out the wire insertion hole 61. Here, at the time of insertion of the terminal 70, since the first lip part 62 and the second lip part 63 are obliquely inclined, one part of the front end face of the terminal 70 first contacts and gradually its contacting area is increased. Therefore, the first lip part 62 and the second lip part 63 are not elastically deformed to be stretched out in its entirety all at once (simultaneously) but are stretched out while gradually enlarging the regions that are being stretched out. Accordingly, as compared with a case in which the first lip part 62 and the second lip part 63 are arranged in the orthogonal direction S to the axial direction P of the wire insertion hole 61, insertion resistance of the terminal 70 is decreased to make the workability better, and damage (breakage) to the sealing member 60 can be restrained.

### SUMMARY

However, with the sealing member 60, when the front end face of the terminal 70 is inserted up to the position as illustrated by the imaginary lines of FIG. 8, it contacts the first lip part 62 as well as the second lip part 63, and it results in stretching out the first lip part 62 and the second lip part 63 simultaneously. Therefore, at this insertion position, there is a problem that insertion resistance of the terminal 70 is increased and a possibility of damage (breakage) to the sealing member 60 becomes high.

Accordingly, the present application was made to solve the above-described problem and it aims to provide a sealing member and a connector that can decrease insertion resistance in all insertion process of the terminal and that can restrain damage at the time of terminal insertion.

A sealing member according to an aspect of the present application includes a wire insertion hole in which an electric wire is to be arranged, and a plurality of lip parts having a protruding shape provided at intervals in an axial direction on an inner circumferential surface of the wire insertion hole. Each of the lip parts has the protruding shape along an inclined direction with respect to an orthogonal direction to the axial direction of the wire insertion hole, and adjacent ones of the lip parts are arranged in regions that do not overlap in the axial direction of the wire insertion hole.

According to the sealing member of the aspect of the present application, at the time of terminal insertion into the wire insertion hole, each of the lip parts is not stretched out all at once in its entirety but is stretched out while gradually enlarging the regions that are being stretched out. Moreover, two lip parts do not become stretched out simultaneously in the whole process of insertion. In other words, in the entire process of insertion, each lip part is stretched out one by one in a sequence. As described above, insertion resistance is reduced at all insertion process of the terminal, and it is possible to make the workability better, and further, damage to the sealing member at the time of terminal insertion can be restrained.

### BRIEF DESCRIPTION OF DRAWINGS

FIG. 1 is a cross-sectional view of a connector according to an embodiment.

FIG. 2 is a perspective view seen from a front face side of a sealing member mat seal) according to the embodiment.

FIG. 3 is a perspective view seen from a rear face side of the sealing member (mat seal) according to the embodiment.

FIG. 4 is a cross-sectional view of a main part of the sealing member (mat seal) according to the embodiment.

FIG. 5A is a cross-sectional view illustrating an insertion process of a terminal into a wire insertion hole according to the embodiment; and FIG. 5B is a cross-sectional view taken along line A-A of FIG. 5A.

FIG. 6A is a cross-sectional view illustrating an insertion process in which insertion of the terminal is further advanced from the position of FIG. 5A; and FIG. 6B is a cross-sectional view taken along line B-B of FIG. 6A.

FIG. 7 is a cross-sectional view of a connector in which a sealing member of a conventional example is utilized.

FIG. 8 is a cross-sectional view of a main part of the sealing member according to the conventional example.

### DETAILED DESCRIPTION

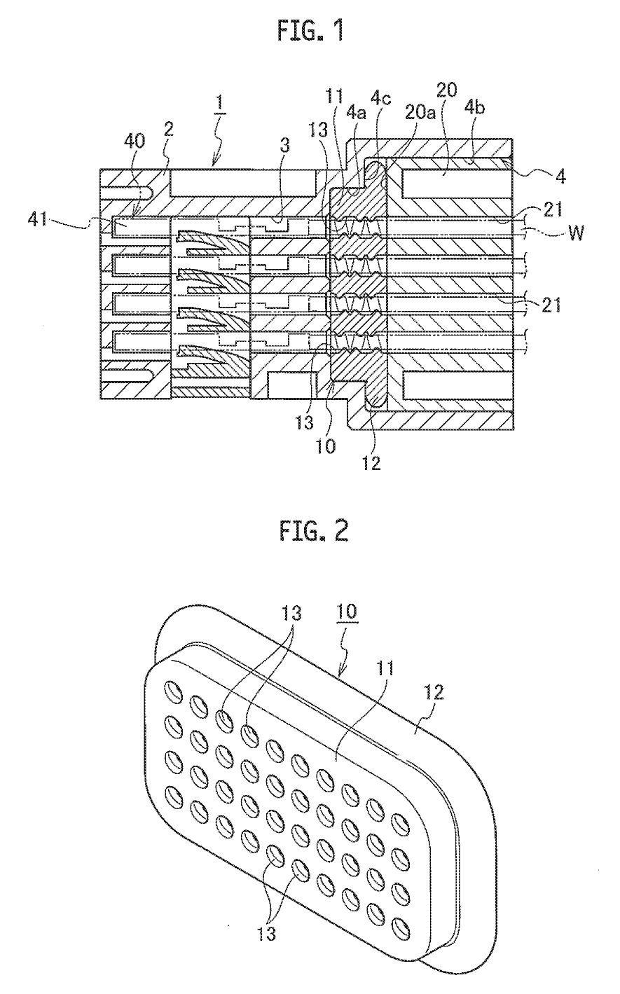

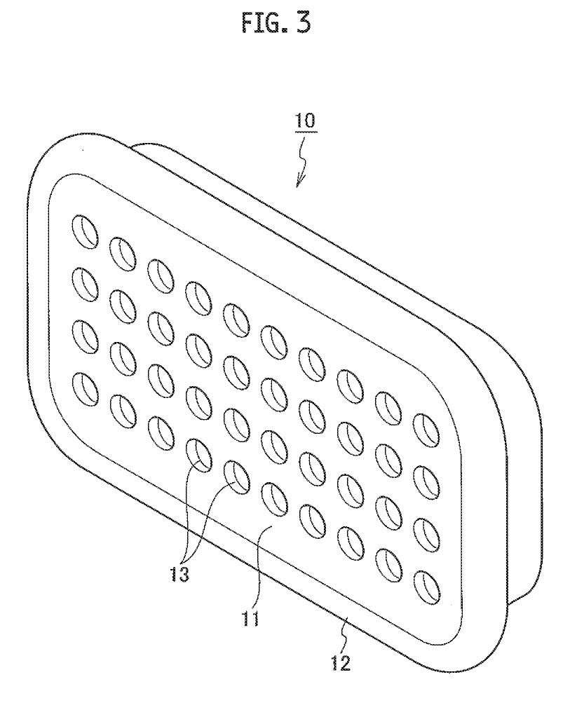

Hereinafter, an embodiment will be explained based on FIGS. 1 to 6.

As illustrated in FIG. 1, a connector 1 according to the embodiment includes a connector housing 2, a mat seal 10 which is a sealing member accommodated in the connector housing 2, a rear holder 20 that holds the mat seal 10 at the rear of the mat seal 10, and a terminal 40 to which an electric wire W to be connected to the connector housing 2 is connected.

A plurality of terminal housings 3 and a mat seal housing 4 arranged at the rear of these terminal housings 3 on the wire draw-out side are formed in the connector housing 2. The mat seal housing 4 is formed to have a wider rear room part 4b than a front room part 4a throughout the whole circumference. Thus, a pressing surface 4c due to a wall surface in a stepped state is formed at the boundary of the front room part 4a and the rear room part 4b.

The mat seal 10 is accommodated in the mat seal housing 4. The mat seal 10 is formed of a soft elastic material such as a rubber material. The mat seal 10 has a mat seal main body 11 that holds the electric wire W and a housing sealing part 12 that protrudes outward from the entire outer circumference of the mat seal main body 11. The mat seal 10 is accommodated in the mat seal housing 4 such that its forward side of the front face of the housing sealing part 12 is arranged in the front room part 4a and its rearward side of the front face of the housing sealing part 12 is arranged in the rear room part 4b respectively. The housing sealing part 12 has a circular cross-section. The housing sealing part 12 is held between the pressing surface 4c of the connector housing 2 and a front face 20a of the rear holder 20. Between the inner circumferential surface of the mat seal housing 4 of the connector housing 2 and the outer circumference of the mat seal 10, it is made waterproof by the mat seal 10.

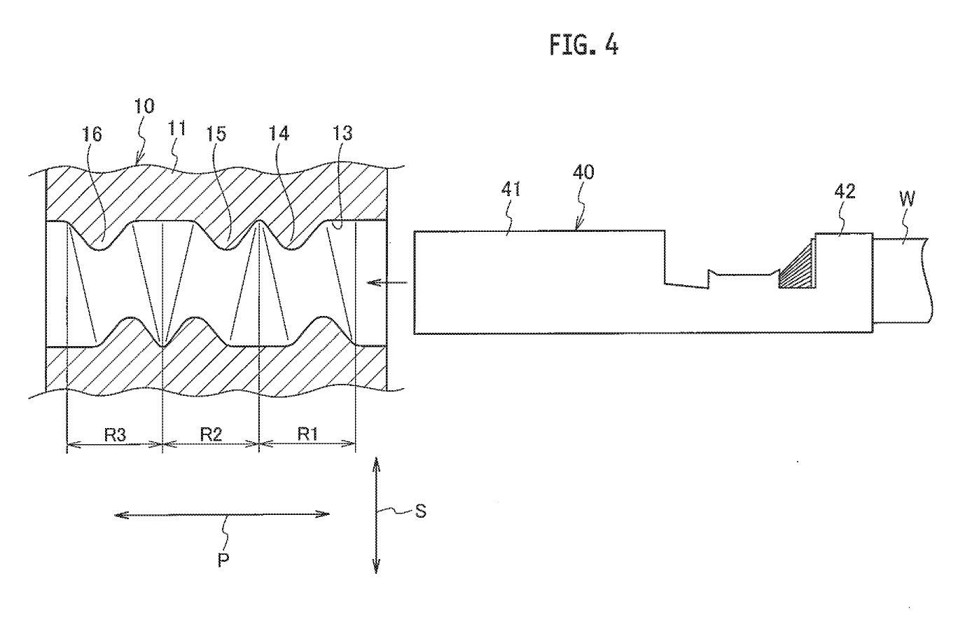

In the mat seal main body 11, wire insertion holes 13 are formed at positions that correspond to respective terminal housings 3. On an inner circumferential surface of each of the wire insertion holes 13, three lip parts, that is, a first lip part 14, a second lip part 15, and a third lip part 16 are provided at intervals in the axial direction of the wire insertion hole 13. Each of the first lip part 14, the second lip part 15, and the third lip part 16 protrudes inward (toward the axial center) from the inner circumferential surface of the wire insertion hole 13. Each of the first lip part 14, the second lip part 15, and the third lip part 16 is mountain shaped whose tip has a circular arc shape. Adjacent lip parts (that is, the first lip part 14 and the second lip part 15, and the second lip part 15 and the third lip part 16) are arranged in regions R1, R2, and R3 (see FIG. 4) that do not overlap in the axial direction P of the wire insertion hole 13. In other words, adjacent lip parts (that is, the first lip part 14 and the second lip part 15, and the second lip part 15 and the third lip part 16) are positioned such that positions of all the protrusions are shifted with respect to the axial direction of the wire insertion hole 13. Adjacent lip parts (that is, the first lip part 14 and the second lip part 15, and the second lip part 15 and the third lip part 16) are set such that their inclination. directions relative to the orthogonal direction S to the axial direction P of the wire insertion hole 13 differ from each other.

The rear holder 20 is arranged in the mat seal housing 4 from the rear face of the connector housing 2. The rear holder 20 has an outer diameter size that enters in the rear room part 4b of the mat seal housing 4 leaving almost no gap therebetween. The rim of the front face 20a of the rear holder 20 closely contacts the housing sealing part 12 of the mat seal 10. In the rear holder 20, electric wire holes 21 are respectively formed at positions that correspond to respective wire insertion holes 13 of the mat seal 10. The inner diameter of each electric wire hole 21 has a size that is larger than the size of the outer diameter of the terminal 40.

The terminal 40 includes a mating terminal connecting section 41 that carries out contact with a mating terminal, and an electric wire connecting section 42 provided integrally with the mating terminal connection section 41.. An external form of the mating terminal connecting section 41 is a rectangular box shape. One end of the electric wire W is connected to the electric wire connecting section 42 by crimping. The terminal 40 is arranged in the terminal housing 3 of the connector housing 2. The electric wire W is drawn outside from the wire insertion hole 13 of the mat seal 10, the electric wire hole 21 of the rear holder 20, and from the rear face of the connector housing 2 (see the imaginary lines of FIG. 1).

In such a structure, between the inner circumferential surface of the mat seal housing 4 of the connector housing 2 and the outer circumference of the mat seal 10, it is made waterproof by the mat seal 10. Between the inner circumferential surface of the wire insertion hole 13 of the mat seal 10 and the electric wire W is made waterproof by the first lip part 14, the second lip part 15, and the third lip part 16 of the mat seal 10.

Next, mounting of the terminal 40 will be explained. After the mat seal 10 and the rear holder 20 have been mounted in the connector housing 2, the terminal 40 with the electric wire W is mounted. The terminal 40 is inserted into the electric wire hole 21 of the rear holder 20 from the rear face side of the connector housing 2, and further inserted into the wire insertion hole 13 of the mat seal 10. In the insertion process to the wire insertion hole 13, an insertion tip of the terminal 40 gradually advances into the wire insertion hole 13 while stretching out the wire insertion hole 13. Here, each of the first lip part 14, the second lip part 15, and the third lip part 16 has a protrusion along a direction that is inclined with respect to the orthogonal direction S to the axial direction P of the wire insertion hole 13. Therefore, the front end face of the terminal 40 does not stretch out the first lip part 14, the second lip part 15, and the third lip part 16 in its entirety all at once but stretches them out while gradually enlarging the regions that are being stretched out.

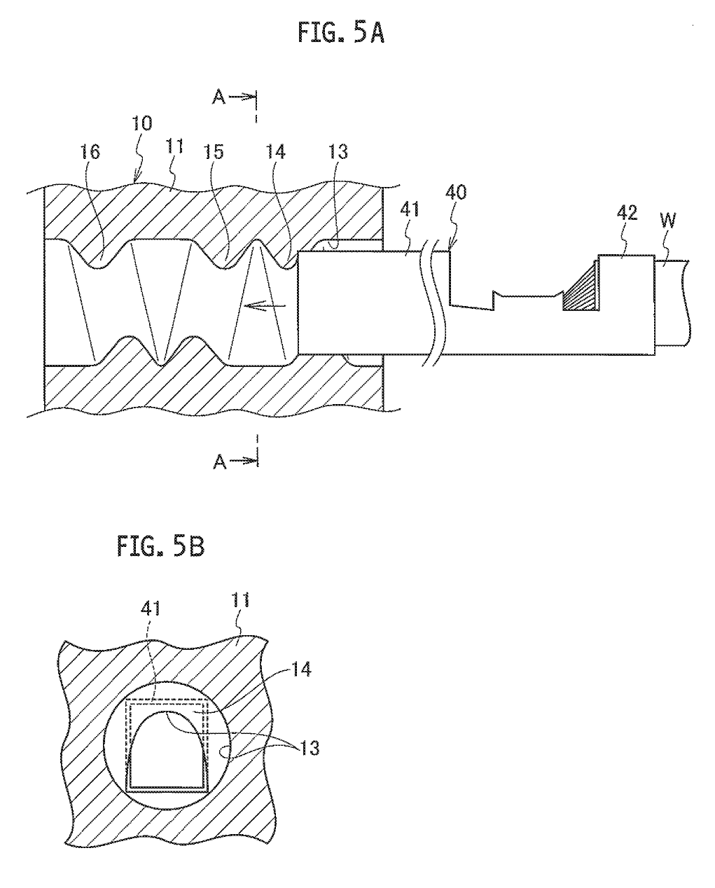

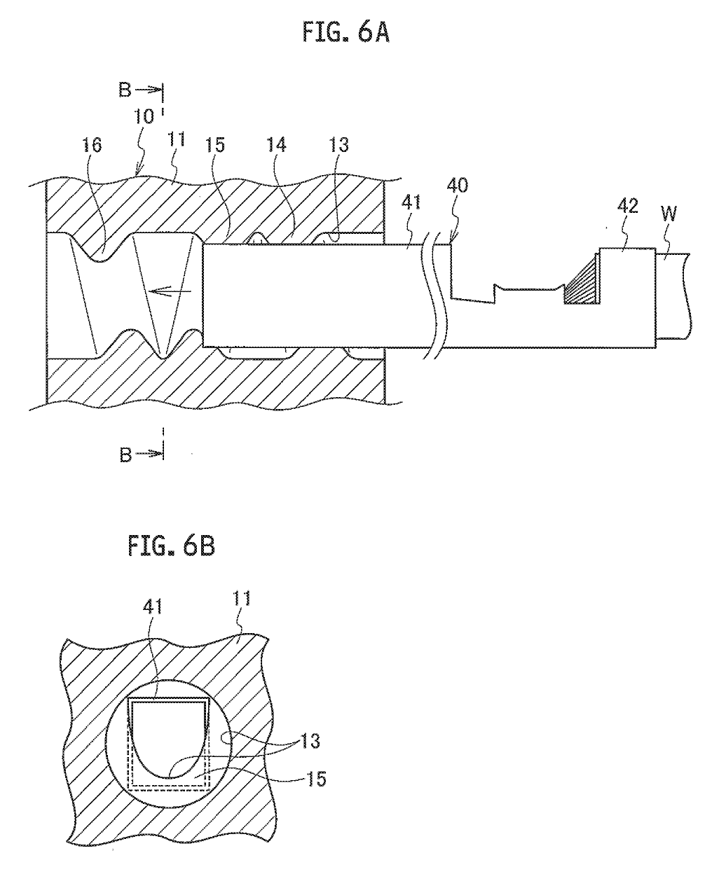

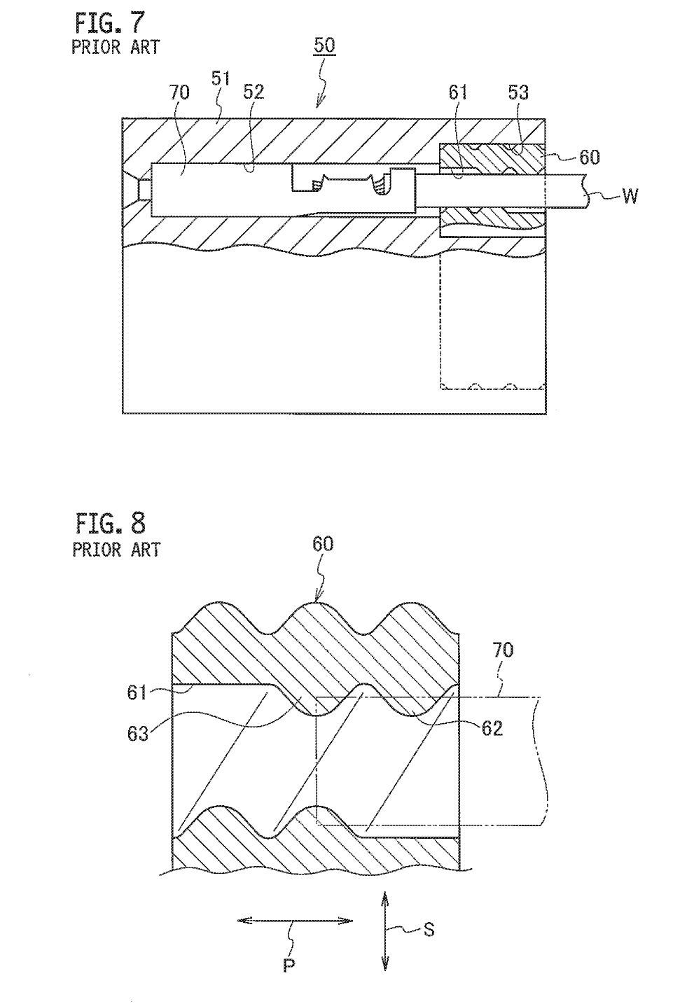

Adjacent lip parts (that is, the first lip part 14 and the second lip part 15, and the second lip part 15 and the third lip part 16) are arranged in regions (R1, R2, and R3) that do not overlap in the axial direction P of the wire insertion hole 13. Therefore, adjacent lip parts (that is, the first lip part 14 and the second lip part 15, and the second lip part 15 and the third lip part 16) do not become stretched out simultaneously. That is, it is inserted while stretching out the lip part 14, 15, and 16 one by one in a sequence. For example, in an insertion position of FIG. 5, one end of the first lip part 14 is stretched out, and after stretching of the first lip part 14 has been completed, as illustrated in FIG. 6, one end of the second lip part 15 is stretched out. In other words, two lip parts (that is, the first lip part 14 and the second lip part 15, or the second lip part 15 and the third lip part 16) do not become stretched out simultaneously in all the insertion process. As described above, since insertion resistance can be decreased in all insertion process of the terminal 40, it is possible to make the workability better, and damage to the mat seal 10 at the time of terminal insertion can be restrained.

Adjacent lip parts (that is, the first lip part 14 and the second lip part 15, and the second lip part 15 and the third lip part 16) are set such that their inclination directions with respect to the orthogonal direction S to the axial direction P of the wire insertion hole 13 differ from each other. With such a structure, the plurality of lip parts 14, 15, and 16 can be arranged in positions that do not overlap with each other within a narrow region, and the thickness of the mat seal 10 (that is, the length of the wire insertion hole 13 in the axial direction) can be made thinner as much as possible. Furthermore, adjacent lip parts (that is, the first lip part 14 and the second lip part 15, and the second lip part 15 and the third lip part 16) may be set such that their inclination directions with respect to the orthogonal direction S to the axial direction P of the wire insertion hole 13 are in the same direction.

In the accommodated position of the mat seal 10 in the connector housing 2, the housing sealing part 12 is held between the pressing surface 4c as a wall surface of the connector housing 2 and the front face 20a as a wall surface of the rear holder 20 in the axial direction P of the wire insertion hole 13. Therefore, since the mat seal main body 11, and consequently the wire insertion hole 13 does not become deformed, sealing of the electric wire W is stabilized. Since the housing sealing part 12 is held between the pressing surface 4c of the connector housing 2 and the front face 20a of the rear holder 20 in a direction of the axial direction P of the wire insertion hole 13, the holding force does not cause deformation of the mat seal main body 11. Therefore, the housing sealing part 12 can be held with a strong three and high sealing properties can be secured. Since high sealing properties can be secured as described above, even if there is a large atmospheric pressure difference between the terminal housing 3 and outside on the rear face side of the connector housing 2, high waterproof properties can be maintained.

While the mat seal 10 of the embodiment has three lip parts 3, there can be two, or four or more lip parts also.

What is claimed is:

1. A sealing member, comprising:
a wire insertion hole in which an electric wire is to be arranged; and
a plurality of lip parts having a protruding shape provided at intervals in an axial direction on an inner circumferential surface of the wire insertion hole, wherein,
each of the lip parts has the protruding shape along an inclined direction with respect to an orthogonal direction to the axial direction of the wire insertion hole, and adjacent ones of the lip parts are arranged in regions that do not overlap in the axial direction of the wire insertion hole.

2. The sealing member according to claim 1, wherein
adjacent ones of the lip parts have their inclined directions with respect to the orthogonal direction to the axial direction of the wire insertion hole that differ from each other.

3. A connector, comprising:
a sealing member comprising a wire insertion hole in which an electric wire is to be arranged, and a plurality of lip parts having a protruding shape provided at intervals in an axial direction on an inner circumferential surface of the wire insertion hole, each of the lip parts having the protruding shape along an inclined direction with respect to an orthogonal direction to the axial direction of the wire insertion hole, adjacent ones of the lip parts being arranged in regions that do not overlap in the axial direction of the wire insertion hole;
a housing sealing part provided integrally with the sealing member at a position that surrounds an entire outer circumference of the sealing member;
a connector housing capable of accommodating the sealing member; and
a rear holder that can be mounted in the connector housing, wherein,
in a position that the sealing member is accommodated in the connector housing, the housing sealing part is held between a wall surface of the connector housing and a wall surface of the rear holder mounted in the connector housing in the axial direction of the wire insertion hole.

4. The connector according to claim 3, wherein
adjacent ones of the lip parts have their inclined directions with respect to the orthogonal direction to the axial direction of the wire insertion hole that differ from each other.
